(19) United States
(12) Patent Application Publication
(10) Pub. No.: US 2011/0076588 A1
(43) Pub. Date: Mar. 31, 2011

(54) FUEL CELL

(76) Inventor: Kunihiro Yamaura, Chita-gun (JP)

(21) Appl. No.: 12/884,391

(22) Filed: Sep. 17, 2010

(30) Foreign Application Priority Data
Sep. 29, 2009 (JP) 2009-223642

(51) Int. Cl. H01M 8/24

(52) U.S. Cl. 429/470

(57) ABSTRACT

A fuel cell is equipped with a laminated body having a plurality of single cells and end plates clamping the single cells, and with an insulating body disposed at a lateral surface portion of the laminated body. The insulating body has a protrusion protruding to the laminated body side, and the laminated body is fastened with the protrusion clamped.

### INCORPORATION BY REFERENCE

The disclosure of Japanese Patent Application No. 2009-223642 filed on Sep. 29, 2009 including the specification, drawings and abstract is incorporated herein by reference in its entirety.

### BACKGROUND OF THE INVENTION

1. Field of the Invention

The invention relates to a fuel cell.

2. Description of the Related Art

There is known a fuel cell having a gas manifold at a lateral surface portion of a fuel cell stack in a lamination direction thereof (e.g., Japanese Patent Application Publication No. 2008-251490 (JP-A-2008-251490)).

However, the fuel cell described in Japanese Patent Application Publication No. 2008-251490 (JP-A-2008-251490) is constructed such that the gas manifold is mounted to an upper portion of the fuel cell stack after the fuel cell stack has been formed. In disassembling this fuel cell stack, the gas manifold is removed, and then the fuel cell stack is disassembled. At the moment when the gas manifold is removed, the fuel cell stack is exposed with single cells connected in series to one another. When an external object comes into contact with the fuel cell stack to cause short-circuiting in this state, a current may flow through the fuel cell stack at a high voltage. This problem may be caused not only in fuel cells having external manifolds but also in fuel cells of other constructions when the fuel cells are disassembled.

### SUMMARY OF THE INVENTION

The invention restrains a current from flowing through a fuel cell stack at a high voltage even when an object from the outside comes into contact with the fuel cell stack in disassembling a fuel cell.

A first aspect of the invention relates to a fuel cell that is equipped with a laminated body having a plurality of single cells and end plates clamping the single cells, and with an insulating body disposed at a lateral surface portion of the laminated body. The insulating body has a protrusion protruding to the laminated body side, and the laminated body is fastened with the protrusion clamped. According to this fuel cell, the insulating body cannot be removed unless the clamped protrusion is released. Therefore, in disassembling the fuel cell, an object from the outside can be restrained from coming into contact with the fuel cell stack. As a result, a current can be restrained from flowing through the fuel cell stack at a high voltage.

The protrusion may be clamped between a corresponding one of the single cells and a corresponding one of the end plates. In this manner, the insulating body can be easily supported by fastening the end plates together.

The insulating body may be formed using part of an external manifold for distributing gas to the single cells. In the fuel cell having the external manifold, the number of parts can be reduced by causing the external manifold to function as the insulating body.

The fuel cell may be equipped with a tension rod for fastening the single cells to the end plates, and the tension rod may penetrate the protrusion. In this manner, the insulating body cannot be removed unless the tension rod is drawn out. Then, when the tension rod is drawn out, the fuel cell is separated into the single cells. Accordingly, contact with the fuel cell stack composed of the laminated single cells can be suppressed.

The invention can be realized in various forms. For example, the invention can be realized in various forms such as a method of manufacturing a fuel cell as well as a fuel cell.

### BRIEF DESCRIPTION OF THE DRAWINGS

The features, advantages, and technical and industrial significance of this invention will be described in the following detailed description of an example embodiment of the invention with reference to the accompanying drawings, in which like numerals denote like elements, and wherein:

FIG. 1 is an explanatory view showing an exterior of a fuel cell equipped with an external manifold;

FIG. 2 is an explanatory view of the fuel cell as viewed in an x-direction shown in FIG. 1;

FIG. 3 is an explanatory view showing part of a cross-section of the fuel cell taken along a cutting line shown in FIG. 2;

FIGS. 4A and 4B are explanatory views showing modification examples;

FIG. 5 is an explanatory view showing another modification example;

FIGS. 6A and 6B are explanatory views showing modification examples of the shape of a protrusion; and

FIG. 7 is an explanatory view showing an example of a construction in which a tension rod penetrates the protrusion.

### DETAILED DESCRIPTION OF EMBODIMENT

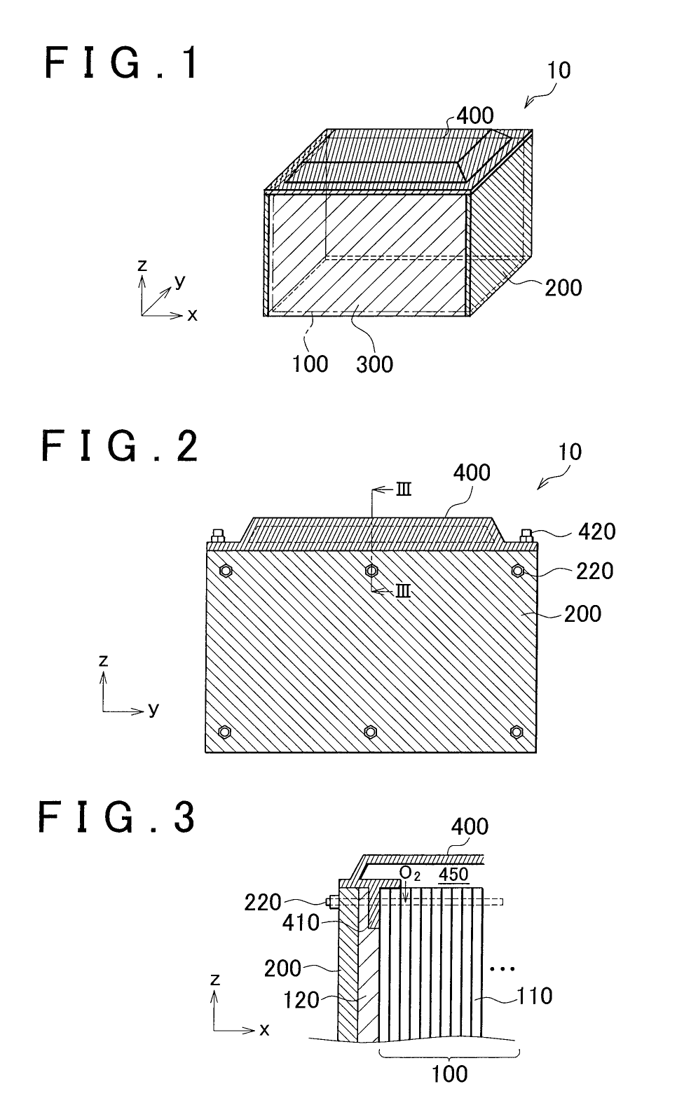

FIG. 1 is an explanatory view showing an exterior of a fuel cell equipped with an external manifold. A fuel cell 10 is equipped with a fuel cell stack 100, end plates 200, fixed plates 300, and an external manifold 400. The end plates 200 are disposed at both ends of the fuel cell stack 100 in a lamination direction (an x-direction in FIG. 1) of single cells (not shown) respectively. The fixed plates 300 are disposed at both ends of the fuel cell stack 100 in a y-direction respectively. The external manifold 400 is disposed above the fuel cell stack 100 (a z-direction in FIG. 1). That is, the fuel cell stack 100 is surrounded by the end plates 200 and the fixed plates 300 in a horizontal direction (the x-direction and the y-direction), and is covered above (the z-direction) with the external manifold 400. It should be noted that bolts and the like for coupling these components are not shown in FIG. 1.

FIG. 2 is an explanatory view of the fuel cell as viewed in the x-direction shown in FIG. 1. In the x-direction, one of the end plates 200 and the external manifold 400 are visible, and the fuel cell stack 100 and the fixed plates 300 are invisible. FIG. 2 shows tension rods 220 and mounting bolts 420, which are not shown in FIG. 1. The tension rods 220 are used to fasten the single cells (not shown) of the fuel cell stack 100 (FIG. 1) to the end plates 200. The mounting bolts 420 are used in joining the external manifold 400 to the fixed plates 300.

FIG. 3 is an explanatory view showing part of a cross-section of the fuel cell taken along a cutting line III-III shown in FIG. 2. The fuel cell stack 100 is composed of a plurality of single cells 110 laminated on one another. Collector plates 120 are disposed outside the single cells 110 in the lamination direction thereof (the x-direction) respectively. The end plates 200 are disposed outside the collector plates 120 respectively. The tension rods 220 penetrate the end plates 200, the collector plates 120, and the single cells 110 to fasten the end plates 200, the collector plates 120, and the single cells 110 together.

The external manifold 400 is formed of, for example, resin, and assumes the shape of a hollow and generally rectangular parallelepiped. The external manifold 400 is open on the fuel cell stack 100 side. Therefore, a space 450 is formed between the external manifold 400 and the fuel cell stack 100. The space 450 is supplied with air. It should be noted that an air introduction portion for the space 450 is not described. This air introduction portion may be connected to a peak portion of the external manifold 400. The single cells 110 have open holes (not shown) on the space 450 side, and air (O₂) is supplied from the space 450 to the respective single cells 110 through these holes.

Protrusions 410 protruding to the fuel cell stack 100 side are formed at outer edge portions at both ends of the external manifold 400 in the x-direction respectively. It should be noted that the external manifold 400 is formed of resin as described above, and that the protrusions 410 can be easily formed during injection molding of the external manifold 400. Each of the protrusions 410 is clamped between a corresponding one of the single cells 110 and a corresponding one of the collector plates 120. The tension rods 220 fasten the end plates 200, the collector plates 120, and the single cells 110 (the fuel cell stack 100) together with the protrusions 410 clamped. It should be noted herein that the external manifold 400 is designed to be irremovable unless the tension rods 220 are loosened to unfasten the fuel cell stack 100. However, in this embodiment of the invention, the tension rods 220 are inserted through those regions where the protrusions 410 do not exist, instead of penetrating the protrusions 410 respectively.

In the fuel cell, a multitude of the single cells 110 with a small electromotive force are connected in series to one another to generate a high voltage. That is, the tension rods 220 apply a tension to the end plates 200 at both the ends, between which the plurality of the single cells 100 are clamped. When the fuel cell stack 100 is formed by connecting in series these single cells 110 to one another, a high voltage can be generated by this fuel cell stack 100. On the other hand, when the tension serving to clamp the plurality of the single cells 110 by the end plates 200 is stopped from being applied due to the unfastening of the fuel cell stack 100 by the tension rods 220, the respective single cells 110 are separated from one another and no longer connected in series to one another, thereby stopping the generation of a high voltage.

According to this embodiment of the invention, when the fuel cell stack 100 is formed by the tension rods 220, the external manifold 400 covers the fuel cell stack 100. Therefore, no external object comes into contact with the fuel cell stack 100, and there is no possibility of short-circuiting. On the other hand, when the fuel cell stack 100 is unfastened by the tension rods 220, the external manifold 400 is removed. Therefore, an external object may come into contact with the single cells 110 (the fuel cell stack 100). However, even when the external object comes into contact with the single cells 110 (the fuel cell stack 100) to cause short-circuiting, a low voltage is generated due to a small electromotive force. Therefore, according to this embodiment of the invention, a current can be restrained from flowing through the fuel cell stack 100 at a high voltage even when an external object comes into contact with the fuel cell stack 100.

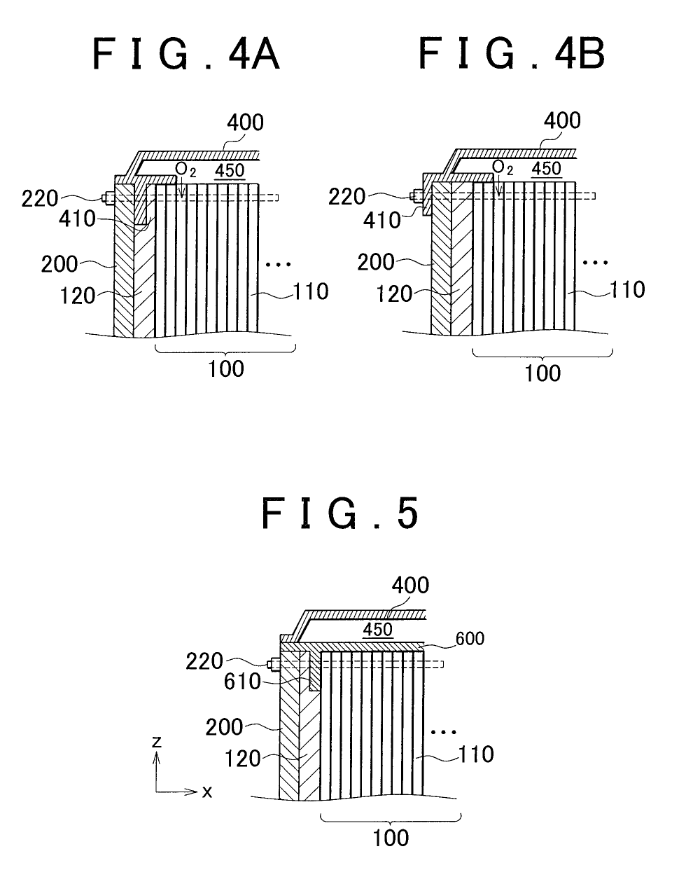

FIGS. 4A and 4B are explanatory views showing modification examples. In this embodiment of the invention shown in FIG. 3, each of the protrusions 410 is clamped between a corresponding one of the single cells 110 and a corresponding one of the collector plates 120. However, as shown in FIG. 4A, each of the protrusions 410 may be clamped between a corresponding one of the collector plates 120 and a corresponding one of the end plates 200. Further, as shown in FIG. 4B, each of the protrusions 410 may be located outside a corresponding one of the end plates 200. In this case, the tension rods 220 penetrate the protrusions 410.

FIG. 5 is an explanatory view showing another modification example. In this embodiment of the invention shown in FIG. 3, the protrusions 410 are formed on the external manifold 400. However, it is also appropriate to adopt a construction in which an insulating plate 600 separate from the external manifold 400 is disposed on an upper surface of the fuel cell stack 100 and protrusions 610 are provided on the insulating plate 600. It should be noted that the protrusions 610 may be formed at various positions as shown in FIGS. 4A and 4B even when the insulating plate 600 is provided. It should be noted that the provision of the protrusions 410 on the external manifold 400 is preferred from the standpoint of reducing the number of parts. It should be noted that the modification example shown in FIG. 5 is also applicable to an inner manifold-type fuel cell unequipped with an external manifold.

It should be noted that although the external manifold 400 or the insulating plate 600 is provided with the two protrusions 410 or 610 in the foregoing embodiment of the invention or each of the modification examples, there may be provided a single protrusion 410 or 610 or more than two protrusions 410 or 610. The support strength can be enhanced by providing a plurality of protrusions.

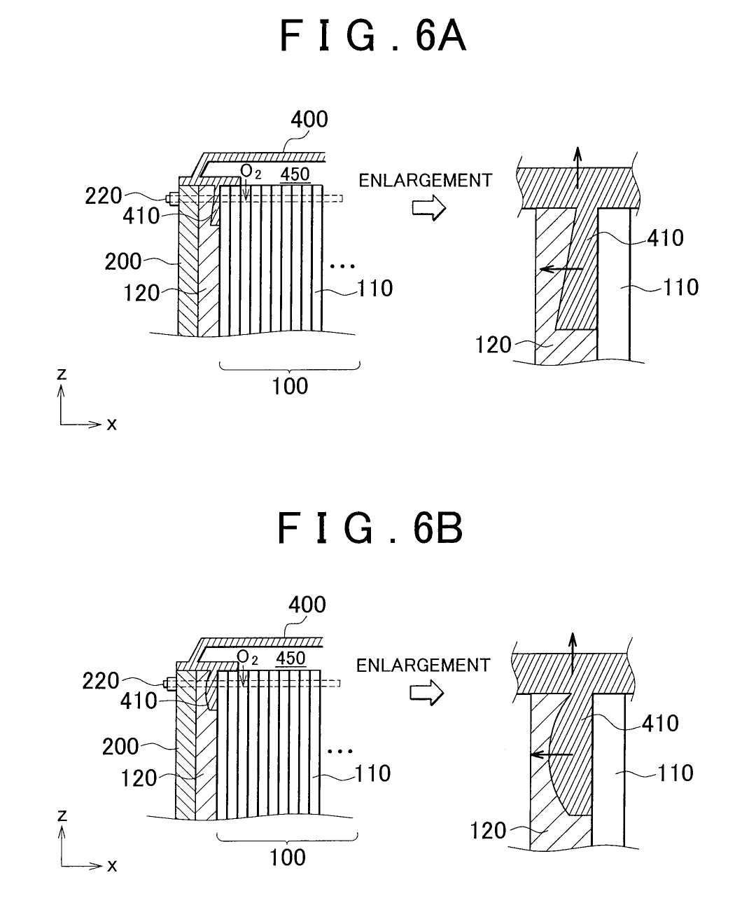

FIGS. 6A and 6B are explanatory views showing modification examples of the shape of the protrusions. As shown in FIG. 6A, the protrusions 410 may assume a tapered shape. Further, as shown in FIG. 6B, the protrusions 410 may assume a curved shape. In the modification examples, when the external manifold 400 is pulled upward in FIG. 6A or 6B, tapered portions or curved portions press the collector plates 120 toward the end plates 200 respectively. As a result, the single cells 110 are easily separated from the end plates 200 respectively. In this manner, the protrusions 410 may assume various shapes except a rectangular shape.

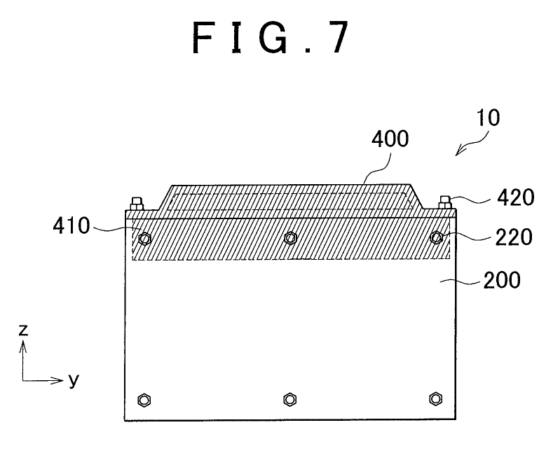

In the fuel cell according to the invention, it is possible to adopt either a construction in which the tension rods 220 penetrate the protrusions 410 or a construction in which the tension rods 220 do not penetrate the protrusions 410. FIG. 7 shows an example of the construction in which the tension rods 220 penetrate the protrusions 410. As shown in FIG. 7, in the case where the tension rods 220 penetrate the protrusions 410, the external manifold 400 or the insulating plate 600 cannot be removed unless the tension rods 220 are drawn out. When the tension rods 220 are drawn out, the fuel cell stack 100 is separated into the single cells 110. Accordingly, in disassembling the fuel cell, an object from the outside can be restrained from coming into contact with the fuel cell stack 100 composed of the laminated single cells 110. As a result, a current can be restrained from flowing through the fuel cell stack 100 at a high voltage.

The embodiment of the invention has been described above on the basis of the examples thereof. However, the foregoing embodiment of the invention is intended to facilitate the understanding of the invention and does not limit the invention. It is obvious that the invention can be modified or improved without departing from the gist thereof or the claims and includes equivalents thereof.

What is claimed is:

1. A fuel cell comprising:
a laminated body having a plurality of single cells and end plates clamping the single cells; and
an insulating body disposed at a lateral surface portion of the laminated body, wherein
the insulating body has a protrusion protruding to the laminated body side, and
the laminated body is fastened with the protrusion clamped.

2. The fuel cell according to claim 1, wherein
the protrusion is clamped between a corresponding one of the single cells and a corresponding one of the end plates.

3. The fuel cell according to claim 1, wherein
the laminated body is equipped with collector plates provided between corresponding ones of the plurality of the single cells and the end plates respectively, and
the protrusion is clamped between a corresponding one of the single cells and a corresponding one of the collector plates.

4. The fuel cell according to claim 1, wherein
the laminated body is equipped with collector plates provided between corresponding ones of the plurality of the single cells and the end plates respectively, and
the protrusion is clamped between a corresponding one of the collector plates and a corresponding one of the end plates.

5. The fuel cell according to claim 1, wherein
the insulating body is formed using part of an external manifold for distributing gas to the single cells.

6. The fuel cell according to claim 1, further comprising
a tension rod for fastening the single cells to the end plates, wherein
the tension rod penetrates the protrusion.

7. The fuel cell according to claim 1, wherein
the protrusion increases in thickness toward the laminated body.

8. A fuel cell comprising:
a laminated body having a plurality of single cells and end plates clamping the single cells;
an insulating body disposed at a lateral surface portion of the laminated body; and
a tension rod for fastening the single cells to the end plates,
wherein
the insulating body has a protrusion protruding to the laminated body side, and
the tension rod penetrates the protrusion.
